(19) United States
(12) Patent Application Publication
(10) Pub. No.: US 2013/0132470 A1
(43) Pub. Date: May 23, 2013

(54) Method and System for Storing Time-Dependent Data

(71) Applicant: Christian Nicholas VARDIN, Maple (CA)

(72) Inventor: Christian Nicholas VARDIN, Maple (CA)

(21) Appl. No.: 13/684,223

(22) Filed: Nov. 22, 2012

Related U.S. Application Data
(60) Provisional application No. 61/562,891, filed on Nov. 22, 2011.

(51) Int. Cl. G06F 15/173

(52) U.S. Cl. CPC G06F 15/173
USPC 709/203

(57) ABSTRACT

A method for processing time-dependent data including downloading source data stored on one or more computer readable media at one or more data sources; wherein said source data includes a plurality of records each of which includes a time stamp; determining by a computer system a time zone offset of said time stamp; converting said time stamp by said computer system to a common time zone stamp; and storing said source data with said common time zone stamp. The time dependent data is preferably energy market data.

### FIELD OF THE INVENTION

The present invention relates generally to data storage systems, and in particular to a method and system for storing time-dependent data.

### BACKGROUND OF THE INVENTION

The storage and analysis of time-dependent data in the field of energy trading is known. Various entities register and make available energy market data. These entities acting as data sources can include, for example, energy producers, energy distributors, and data aggregators. In order to better understand trends in energy markets prices, demand and supply, and reliability, it can be desirable to collect, store and analyze energy market data from a number of sources in a number of regions.

The energy market data can include the time period, generally in five-minute periods or in hours, for which energy was purchased, the amount of energy purchased, the price, the amount of energy delivered, and the parties. Data sources typically register time information for energy market data according to the time zone in which the data source is located. Further, the time information may include adjustments for daylight savings time, depending upon when the energy market data is collected.

Where some of the sources fall into separate and distinct time zones, or otherwise register time information differently, energy market data from different data sources may not be directly comparable. In one example, energy market data for the period between 6 PM and 7 PM from a data source in a first time zone may not align with energy market data for the period between 6 PM and 7 PM from another data source in a second time zone. In another example, two different regions may differ on the days that they switch to and from daylight savings. As the energy market data typically includes time information that is local to the region and day that the information is captured for, it may be erroneous to directly compare time-dependent data received from two data sources in the different regions simply based on the time information included in the energy market data.

In order to compensate for these time discrepancies between energy market data entries, some parties that aggregate data from a set of data sources use an offset approach; that is, by adding or subtracting the number of hours of difference (an “offset”) between two time zones to the energy market data during analysis. The determined offset is applied to all hours in the dataset. While this approach works satisfactorily to “align” energy market data for a single summer or single winter period, it does not adjust for Daylight Savings Time (“DST”). Where the energy market data being analyzed is for a time period that spans both standard time and DST, the data before or after the DST crossover is misaligned.

For example, consider two months of energy market data March and April. For simplicity of explanation, let it be assumed that “spring forward” occurs on April 1. It is now May 1, and a trader is looking back over the past two months of energy market data. The trader desires to buy from a Central Standard Time (“CST”) time zone and sell into an Eastern Daylight Time (“EDT”) time zone. The trader may wish to view the price action hour-by-hour for these two time zones, and perform analysis on it. To align and view the energy market data, the trader picks a time zone; typically in the north-east, EDT is selected. Using the crude “offset” approach to shift CST to align with EDT, all CST data shifts by two hours: one for the difference between CST and EST, and then one more hour as the trader is in DST. For March, however, there was no DST, so the time difference for all prices in March is incorrect by one hour. Therefore, all analysis for March data is wrong using the “offset” method.

Another approach adopted by some parties is to further adjust the energy market data during the analysis phase for all years using the “spring forward” and “fall back” date rules for DST for the current year. While this approach is an improvement on the offset approach, there are issues with it. For datasets that span several years, the rules of when DST “spring forward” and “fall back” occur have changed over the years. Thus, if a trader wants to know how the energy market behaved in March/April or in October/November over the past five years, several days and perhaps a week of the data points will be misaligned for each spring and fall.

It is therefore an object of the invention to provide a novel method and system for storing time-dependent data.

### SUMMARY OF THE INVENTION

According to one embodiment of the invention, there is provided a method for processing time-dependent data including downloading source data stored on one or more computer readable media at one or more data sources; wherein the source data includes a plurality of records each of which includes a time stamp; determining by a computer system a time zone offset of the time stamp; converting the time stamp by the computer system to a common time zone stamp; and storing the source data with the common time zone stamp.

In one aspect of this embodiment, the method includes prior to the determining step, normalizing the source data such that the time stamp is in a common format.

In another aspect of this embodiment, the common format comprises one of a 12-hour format and a 24-hour format.

In another aspect of this embodiment, the time-dependent data comprises energy market data.

In another aspect of this embodiment, the method further includes determining whether an adjustment is required for daylight savings time prior to the determining step.

In another aspect of this embodiment, the method further includes prior to the storing step, calculating by the computer system priority time zone stamp information, wherein the priority time zone is determined by an operator of the computer system.

In another aspect of this embodiment, the method further includes determining whether the time zone stamp information is indicative of a peak hour usage.

In another aspect of this embodiment, the method further includes storing a result of the determining whether the local time zone stamp information is indicative of peak hour usage

According to another embodiment of the invention, there is provided a system for processing time-dependent data including a computer system having a computer readable medium in communication therewith; the computer readable medium having instructions thereon for carrying out the method herein described.

### DESCRIPTION OF THE DRAWINGS

FIG. 2 shows a schematic diagram of the system of FIG. 1;

FIG. 3 shows various logical components of the system of FIG. 1; and

FIG. 4 is a flowchart of the method of storing time-dependent data used by the computer system of FIG. 1.

### DETAILED DESCRIPTION OF THE EMBODIMENTS

FIG. 1 shows computer system 20 for storing time-dependent data in communication with a plurality of data sources 24A, 24B and 24C via a large communications network, such as the Internet 28. The data sources 24 register and make available energy market data. The data sources can include, for example, energy producers, energy distributors, and data aggregators. The data sources can be located in separate and distinct time zones, or otherwise register time information differently. For example, two different regions in a single time zone may differ on the days that they switch to and from daylight savings. The energy market data is provided by the data sources 24 in the form of a file, such as a text file in comma-separated value (“CSV”) or eXtensible Markup Language (“XML”) format, or a Microsoft Excel workbook. The file may be made publicly available or, alternatively, can be made available only to authorized parties. The computer system 20 retrieves and stores the energy market data made available by the data sources 24 as will be described below.

A client computer 32 is in communication with the computer system 20 for analyzing the energy market data aggregated by the computer system 20. The client computer 32 is operated by an energy trader. The energy trader uses the client computer 32 to formulate a strategy for purchasing or trading energy, perhaps to meet the demands of a region served by an energy provider that the energy trader serves. In order to better understand trends in energy markets prices, demand and supply, and reliability, it can be desirable to collect, store and analyze energy market data from a number of sources in a number of regions. As energy can be bought from many different regions and transmitted to a region needing the energy, it is desirable to analyze trends in prices for energy from various different regions to formulate a strategy for meeting the demand of the region being served.

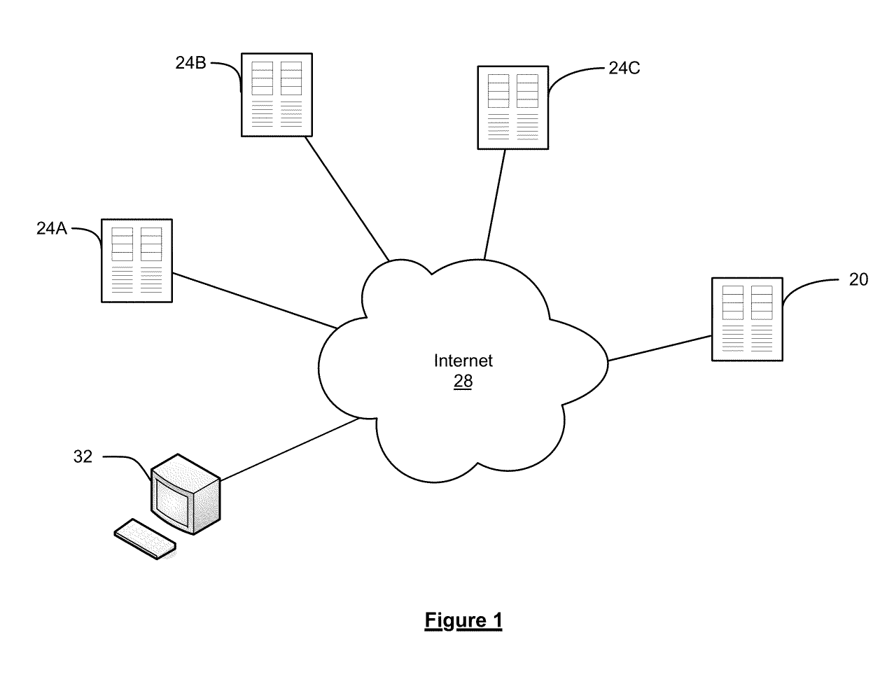

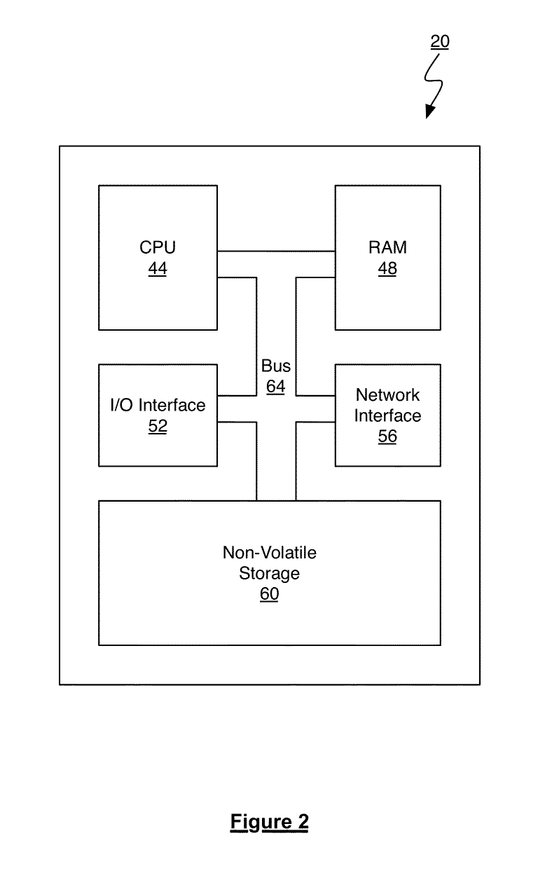

FIG. 2 shows various physical elements of the computer system 20. As shown, the computer system 20 has a number of physical and logical components, including a central processing unit (“CPU”) 44, random access memory (“RAM”) 48, an input/output (“I/O”) interface 52, a network interface 56, non-volatile storage 60, and a local bus 64 enabling the CPU 44 to communicate with the other components. The CPU 44 executes an operating system, and software for receiving, storing, and serving energy market data. RAM 48 provides relatively-responsive volatile storage to the CPU 44. The I/O interface 52 allows for input to be received from one or more devices, such as a keyboard, a mouse, etc., and outputs information to output devices, such as a display and/or speakers. The network interface 56 permits communication with other systems. Non-volatile storage 60 stores the operating system and programs, including computer-executable instructions for implementing the software for receiving, storing, and serving the energy market data. During operation of the computer system 20, the operating system, the software and the data may be retrieved from the non-volatile storage 60 and placed in RAM 48 to facilitate execution.

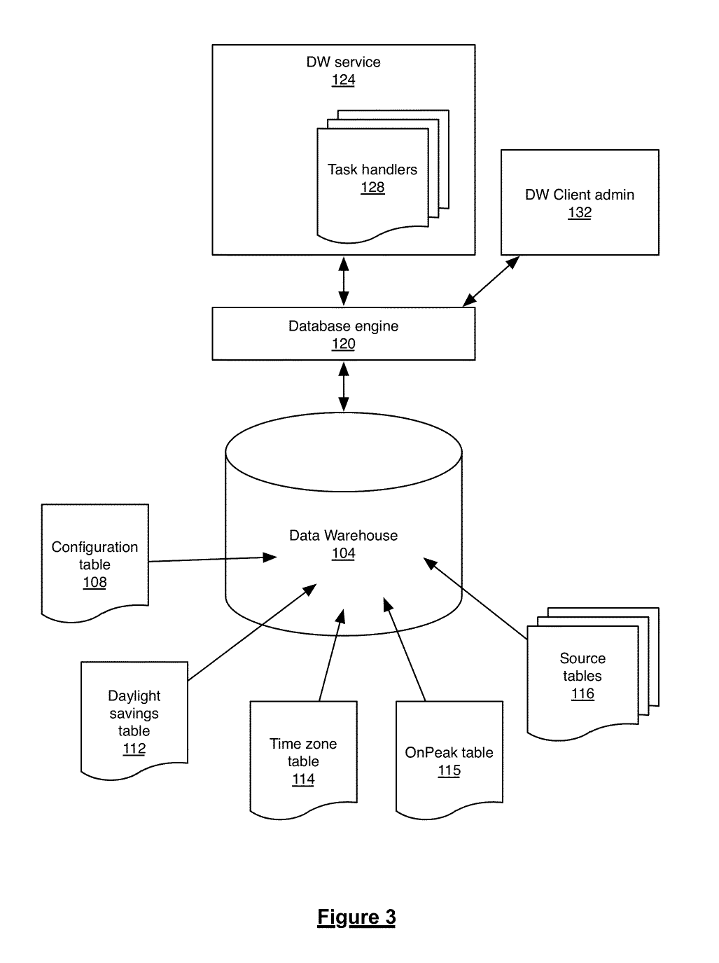

FIG. 3 shows a number of logical elements of the computer system 20. The computer system 20 includes a data warehouse 104. The data warehouse 104 is a database that stores aggregated energy market data, configuration data, and time adjustment data. The configuration data is stored in a configuration table 108. The time adjustment data is stored in the configuration table 108 and a daylight savings table 112. The time difference between GMT and standard time for a set of time zones is stored in a time zone table 114. Various configurations of on-peak hour time periods for a week are stored in an onpeak table 115. The aggregated energy market data is stored in a set of source tables 116. A database engine 120 manages access to the configuration table 108, the daylight savings table 112 and the source tables 116.

The configuration table 108 stores configuration data for retrieving, interpreting and storing energy market data from the data sources 24. Each data source is represented by a record in the configuration table 108. In particular, the configuration table 108 includes the following information for each data source:

### Task Handler Name:

This field specifies the name of a task handler coded to handle the retrieval and importation of the energy market data from a data source 24 into a source table 116.

### Source Table Name:

This field identifies the name of the particular source table 116 into which data is to be imported. Data from each data source 24 is stored in a separate source table 116.

### Source Data Location:

This field identifies the general location from which the energy market data may be obtained for a data source 24. This is the static portion of the URL that identifies the location of the energy market data for a data source 24. In addition, the source data location field specifies the protocol to be used to retrieve the energy market data from the data source 24. An example of a source data location for a data source 24 is “http://www.energyorg.com/datal”

### Source Data Name Configuration:

This is a set of fields that identifies the particular file name in which current energy market data is stored by the data source 24 in the source data location. This represents the variable portion of the URL that identifies the location of the energy market data for a data source 24. For example, if a data source 24 generates a CSV file for each day, the filename may be in the format “YYYYMMDD.csv”, where YYYY is the year to four digits, MM is the month to two digits with a leading zero if required, and DD is the day to two digits with a leading zero if required. Of note is that if subdirectories are used to separate the location in which energy market data files are stored by a data source 24, the source data name configuration information specifies this location. For example, the energy market data may always be stored in a file called “data.csv”, but this file may be stored in a directory named to match the day to which the data relates. In this case, the source data name configuration may result in a string such as “20110322/data.csv”. The data source 24 may update the data file for a period during the course of the period. Thus, where a data source 24 generates a data file for each day, the data file may be updated once hourly with new energy market data. The name generated using the source data name configuration is appended to the source data location to generate the URL from which the current source data. Using the above examples, the URL for the current energy market data made available by a data source 24 may be “http://www.energyorg.com/data/20110322.csv” or “http://www.energyorg.com/data/20110322/data.csv”.

### Time Zone:

This field identifies the time zone for the time information in the energy market data. This is typically the time zone in which the data source resides, but can alternatively be another time zone specified by the data source.

### Daylight Savings Configuration:

This field is used to specify a configuration in the daylight savings table 112 for switching between daylight savings and standard time. In some cases, a region may switch to daylight savings on a different day and/or time than other regions in the same time zone. In other cases, a region may ignore daylight savings. For such cases, an alternative entry in the daylight savings table 116 is specified in this field.

### OnPeak Region:

This field specifies a one of the configurations of on-peak time periods defined in the onpeak table 115.

### Currency:

This field specifies the currency in which prices are provided in the energy market data. The currency for energy market data can be later used during analysis for converting the price of the energy to another currency during analysis.

### Schedule Configuration:

This is a set of fields that specifies the frequency with which energy market data is to be retrieved, the time at which to retrieve the energy market data, the number of times to repeat the retrieval attempt if previous attempts for an occurrence failed, the wait time between retrieval attempts upon failure, and periods during which energy market data is not to be retrieved, if any.

The daylight savings table 112 stores a configuration specifying when daylight savings “kicks in” and “kicks out” in different areas. A default daylight savings configuration is specified for each time zone and then one or more alternative configurations for regions or groups of regions in the time zone can be specified. Each configuration specifies the day and time, in GMT, at which daylight savings kicks in and kicks out. A configuration for a region that has not adopted daylight savings does not include dates and times.

For purposes of this discussion, time may be understood to mean date and time, where appropriate.

The computer system 20 executes software for receiving, storing, and serving energy market data. The software includes a data warehouse (“DW”) service 124. The DW service 124 performs the retrieval and storage of energy market data in the data warehouse 104, and handles queries on the energy market data stored in the data warehouse 104. The DW service 124 utilizes a set of task handlers 128 to perform the retrieval, parsing/transformation, and loading of the energy market data into source tables 116 in the data warehouse 104. Further, the task handlers 128 report the progress of these tasks by generating logs. The task handlers 128 are scripts that can be customized to handle various formats for the energy market data. While, herein, it may be said that task handlers 116 perform certain functions, it will be understood that these functions are performed when the task handlers 116 are executed by the DW service 112.

A DW client admin module 132 enables the configuration of the configuration table 108 and the daylight savings table 112, the viewing and reporting of logs, and can be used to manually download energy market data.

When the computer system 20 is initialized, the DW service is initialized and retrieves the configuration table 108 from the data warehouse 104. The configuration table 108 provides a schedule for the retrieval of energy market data from the data sources 24. It directs the DW service 124 when to launch each task handler 128 for each data source 24. The DW service 124 loads the configuration table 108 into memory and schedules for each data source 24 when to commence the process of retrieving the energy market data from each data source.

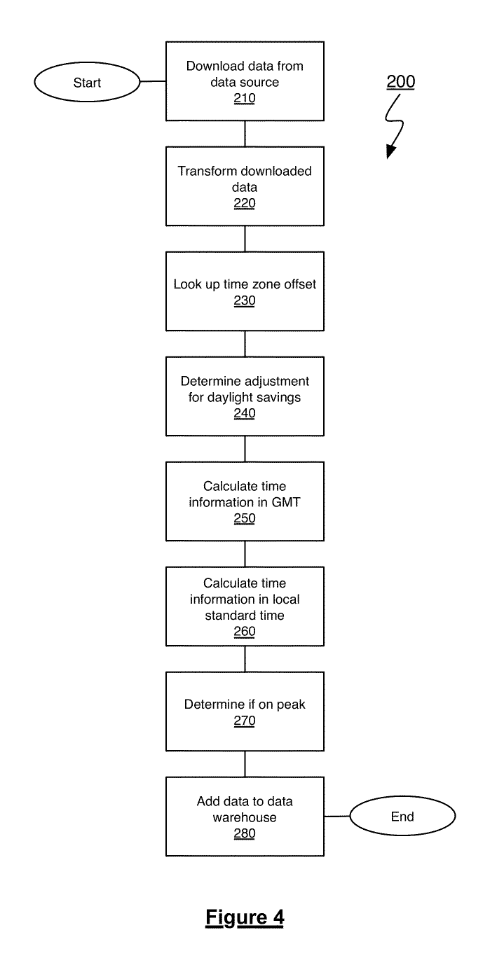

FIG. 4 is a flowchart of a method 200 of retrieving and storing energy market data from a data source 24 used by the computer system 20. The method 200 commences with the downloading of energy market data from a data source (210). When the schedule configuration for a data source 24 specified in the configuration table 108 stipulates that energy market data is to be retrieved from the data source 24, the DW service 124 launches the task handler 128 specified in the configuration table 108. The DW service passes the source table name, the source data location, the source data name configuration, the time zone, and the daylight saving configuration to the task handler 128 as parameters. The task handler 128 generates the URL for the current energy market data available from the data source 24 using the source data location and the source data name configuration. Using the generated URL, the task handler 128 queries the data source 24 and retrieves the desired energy market data.

The energy market data from a data source 24 can include, for example, the following information for each of a set of time periods:
energy source identifier (this is of interest when obtaining data that has already been aggregated for a number of energy sources)
day and time for the time period (typically in the local time of the energy source; the day and time can be for the start or end of a time period of a pre-defined length, such as five minutes or one hour)
average purchase price for energy during the time period
energy purchased
energy delivered

Once the energy market data has been downloaded from the data source 24, the energy market data is transformed (220). During transformation, the format of the energy market data from the data source 24 is modified so that it is consistent with a standard format for all energy market data from all data sources 24. For example, if a data source 24 provides time information using a 24-hour format, and the standard format for time information for all energy market data in the source tables 116 is in 12-hour format, then the time information is transformed to comply with the standard format.

Then, the time zone offset for the data source is looked up (230). The task handler 128 uses the time zone provided as a parameter and looks up the time offset between the standard time for the time zone of the data source 24 and GMT. This is available by looking up the time zone in the time zone table 114.

Next, the adjustment, if any, for daylight savings is determined for the energy market data (240). The daylight savings configuration is looked up in the daylight savings table 112 to determine if the day and time for the energy market data falls within a period during which daylight savings are in effect for the time zone of the data source. The daylight savings adjustments are then registered for the day and time for each entry in the energy market data.

Once the time zone offset and the daylight savings adjustments have been determined, the day and time is determined in GMT by applying the time zone offset (a constant for all times in the data) and the daylight savings adjustments (determined individually for each day and time specified in the data) (250).

Next, the day and times are determined for a priority time standard (260). The priority time standard can be the local standard time of a trader. These are determined by applying the difference between GMT and the standard time for the time zone of the trader. It can be beneficial to convert the times in the data to the local standard time of a trader to facilitate comparisons.

It is then determined whether the time period represented by each entry in the energy market data is on peak hours (270). The task handler 128 looks up the onpeak region specified in the configuration table 108 for the energy source in the on-peak table 115 to determine which hours of the week are considered on-peak hours for the region of the energy source. Each region may have a different configuration of on-peak hours for the week.

The task handler 128 then places the augmented energy market data in the data warehouse 104 (280). In particular, the task handler 128 inserts the original energy market data together with the days and times in GMT and the local standard time of the trader(s) in the source table 116 specified by the configuration table 108.

The energy market data stored in the source tables 116 can include, for example, the following fields:
energy source identifier (this is of interest when obtaining data that has already been aggregated for a number of energy sources)
day and time for the time period (typically in the local time of the energy source)
purchase price
energy purchased
energy delivered
day and time GMT
day and time in standard time of trader
on-peak (Boolean based on whether period deemed to be during peak period for region of energy source)

If the source table 116 already contains entries matching those in the energy market data just processed, the computer system 20 replaces the energy market data in the source table 116 with the newer energy market data. Alternatively, all historical versions of energy market data can be maintained to enable auditing, etc.

The computer system 20 stores historical exchange information for the value of various currencies handled by the computer system 20. Using this information, currencies can be converted during analysis.

By pre-processing the energy market data to generate a time in a standardized uniform time system for each entry, the stored energy market data from multiple sources relating to the same time period can be rapidly grouped and compared for analysis.

While the computer system is shown as a single physical computer, it will be appreciated that the computer system can include two or more physical computers in communication with each other.

1. A method for processing time-dependent data comprising
downloading source data stored on one or more computer readable media at one or more data sources; wherein said source data includes a plurality of records each of which includes a time stamp;
determining by a computer system a time zone offset of said time stamp;
converting said time stamp by said computer system to a common time zone stamp;
storing said source data with said common time zone stamp.

2. The method according to claim 1, further comprising, prior to said determining step, normalizing said source data such that said time stamp is in a common format.

3. The method according to claim 2, wherein said common format comprises one of a 12-hour format and a 24-hour format.

4. The method according to claim 1, wherein said time-dependent data comprises energy market data.

5. The method according to claim 4, further comprising determining whether an adjustment is required for daylight savings time prior to said determining step.

6. The method according to claim 4, further comprising, prior to said storing step, calculating by said computer system priority time zone stamp information, wherein said priority time zone is determined by an operator of said computer system.

7. The method according to claim 6, further comprising determining whether said time zone stamp information is indicative of a peak hour usage.

8. The method according to claim 6, further comprising storing a result of said determining whether said local time zone stamp information is indicative of peak hour usage

9. A system for processing time-dependent data comprising
a computer system having a computer readable medium in communication therewith; said computer readable medium having instructions thereon for:
downloading source data stored on one or more computer readable media at one or more data sources; wherein said source data includes a plurality of records each of which includes a time stamp;
determining a time zone offset of said time stamp;
converting said time stamp to a common time zone stamp;
storing said source data with said common time zone stamp.

10. The system according to claim 9, wherein said instructions include instructions for normalizing said source data such that said time stamp is in a common format.

11. The system according to claim 10, wherein said common format comprises one of a 12-hour format and a 24-hour format.

12. The system according to claim 9, wherein said time-dependent data comprises energy market data.

13. The system according to claim 12, wherein said instructions include instructions for determining whether an adjustment is required for daylight savings time prior to said determining step.

14. The system according to claim 12, wherein said instructions include instructions for calculating by said computer system priority time zone stamp information, wherein said priority time zone is determined by an operator of said computer system.

15. The system according to claim 14, wherein said instructions include instructions for determining whether said time zone stamp information is indicative of a peak hour usage.

16. The system according to claim 14, wherein said instructions include instructions for storing a result of said determining whether said local time zone stamp information is indicative of peak hour usage.
